(19) United States
(12) Patent Application Publication
(10) Pub. No.: US 2009/0185761 A1
(43) Pub. Date: Jul. 23, 2009

(54) METHOD OF GENERATING IMAGE FILE

(75) Inventors: Jiang HE, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/016,268

(22) Filed: Jan. 18, 2008

(51) Int. Cl. G06K 9/54

(52) U.S. Cl. 382/305

(57) ABSTRACT

A method of generating an image file may generate corresponding image files from data units in a first storage device of a source. The method of generating an image file includes generating an image file head according to hardware parameter information of the first storage device; partitioning the first storage device into a plurality of data units with the same size; performing a compression process to compress data in the data units, respectively, thereby generating corresponding compressed data blocks; sequentially storing the compressed data blocks in a data area of the image file; creating an index table to use an index value to record start positions of the data units in the first storage device and positions of the compressed data blocks in the data area into the index table; and creating a file foot information to mark a file length of the image file.

### BACKGROUND OF THE INVENTION

1. Field of Invention

The present invention relates to a method of generating an image file, and more particularly to a method of generating an image file having an improved data structure.

2. Related Art

Common users may feel troublesome in installing a computer system and application programs thereof because they should be familiar with the settings about peripheral devices and the computer system. Furthermore, each installation will spend a lot of time, and re-installation is needed if any error occurs in the first installation period. In order to save installation time, a method of backing up a computer system has been provided.

The so-called computer system backup is to back up the data in storage devices of a computer system from a source, including system information or application programs. If the computer system suffers any malfunctions or damages in future use, the computer system may be restored to the configuration before the data backup as long as a user restores the backup data into the computer system and it is unnecessary for the user to devote care to setting a computer system and installing application programs. Furthermore, the restoration time is much less than the time spent in the installation of the computer system.

Currently, PC (for example, notebook) manufacturers usually pre-install operating systems such as Microsoft Windows System in PCs before leaving factories. Since such operating systems have a large amount of data and take a lot of time to install, the restoration technology of an image file is often used to perform pre-installation of operating systems and/or other application programs on the PCs in the factories, so as to achieve the object of quick installing an operating system, thereby improving the productive efficiency of product lines.

A conventional method of generating an image file is shown in FIG. 1, which is a schematic view of generating an image file. Read relevant information about storage devices (here referring to a hard disk for installing an operating system and/or application systems) of a source (Step S110), in which the relevant information includes, for example, the quantity of sectors of the storage device, positions of files, and the quantity of the files. Then, perform image file processing according to the relevant information of the storage device (Step S120), so as to compress the files in the storage device according to the relevant information and rearrange the compressed files.

Generally speaking, the conventional method of backing up an image file factually may achieve the backup advantage on the direct backup between the storage devices, for example, restoring the image file from the source to the storage device at a destination by using an optical disk or other different storage media. However, if the transmission from the source to the destination is finished through Internet, the following problems may possibly occur. 1. The image file must be received sequentially from the beginning; and 2. if data is missed in the transmission, the transmission should be performed again, thereby wasting a lot of time.

The main reason lies in the composition of the data structure for the image file. In a common data structure for an image file, operations such as arrangement and compression are performed according to file storage positions in the storage device. In order to recreate an image file, recombination information about the image file is required. For example, the recombination information may be stored in the file head or file foot of the image file. Other destinations cannot restore the data in the image file according to the recombination information until the image file has been received.

In addition, disk storage mechanism provided by operating systems may have different limitations of the storage size of the image file. For example, in the FAT disk storage mechanism provided by Microsoft, FAT-16 limits a single file to be no more than 2 GB, and FAT-32 limits a single file to be no more than 4 GB. If the first storage device of the source has a size larger than the limitation on its storage file, the image file cannot be processed.

### SUMMARY OF THE INVENTION

In view of the aforementioned problem, the present invention is mainly directed to provide a method of generating an image file, which may generate corresponding image files from data units in a first storage device of a source and store the image files in another storage device.

In order to achieve the aforementioned object, the preferred method of generating an image file provided by the present invention includes generating an image file head according to hardware parameter information of the first storage device; partitioning the first storage device into a plurality of data units with the same size; performing a compression process to compress data in the data units, respectively, thereby generating corresponding compressed data blocks; sequentially storing the compressed data blocks in a data area of the image file; creating an index table to use an index value to record start positions of the data units in the first storage device and positions of the compressed data blocks in the data area into the index table; and creating a file foot information to mark a file length of the image file.

According to the image file provided by the present invention, the image file may be restored in transmission without considering the receiving sequence. In a network transmission period, if the destination has a missed compressed data block, it may firstly restore the data which has been received. Furthermore, in the present invention, the sizes of the data units may be adjusted according to different file storage mechanisms, so that the size of the image file of the present invention may not be limited by the capacity of files such as EXT, NTFS, FAT16, or FAT32.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the conventional method of generating an image file;

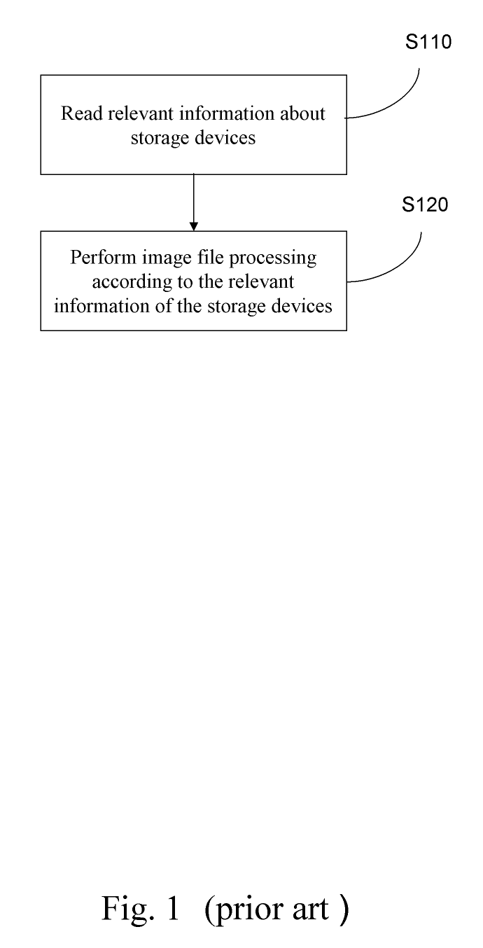

FIG. 2 is a flow chart of the method of generating an image file according to the present invention;

FIG. 3a is a schematic view of the data structure for the image file according to the present invention;

FIG. 3b is a schematic view of the index table according to the present invention;

FIG. 3c is a schematic view of the data structure of the compressed data blocks;

FIG. 3d is a flow chart of generating the compressed data blocks;

FIG. 4 is a schematic view of the process of restoring a destination through network according to the present invention; and

FIG. 5 is a timing graph of the transmission by using the multicasting transmission technology according to the present invention.

### DETAILED DESCRIPTION OF THE INVENTION

In the present invention, a corresponding image file is generated according to a disk structure of a storage device of a source. The source may be a PC, a notebook, a tablet PC, or a mobile computing device. In this embodiment, the source includes a first storage device. The storage device may be a hard disk, a redundant array of independent disks (RAID), or a memory card.

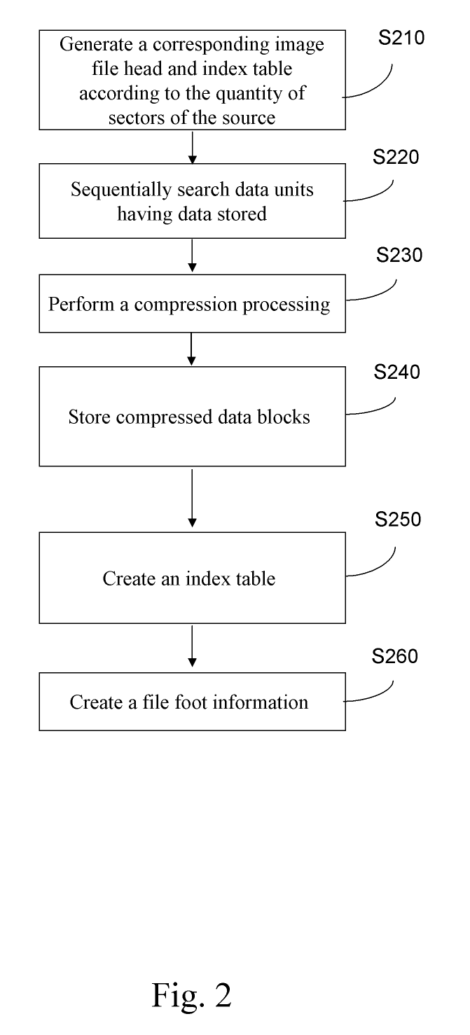

Referring to FIG. 2, a flow chart of the method of generating an image file according to the present invention is shown. The image file of the first storage device is generated through performing the following steps by using a computer. Generate an image file head according to hardware parameter information of the first storage device (Step S210). If the first storage device is a hard disk, the hardware parameter information includes a head, a cylinder, and a sector.

Partition the first storage device into a plurality of data units with the same size (Step S220). The size of one data unit may be determined depending on a disk storage mechanism to be processed as an image file. For example, in a preferred embodiment of the present invention, each of the data units may store 2 MB of data under an ideal situation.

Perform a compression process (Step S230) to compress the data in the data units, respectively, thereby generating corresponding compressed data blocks. Store the compressed data blocks (Step S240), and sequentially store the generated compressed data blocks in a data area of the image file. Create an index table (Step S250) to use an index value to record starting positions of the data units in the first storage device and positions of the compressed data blocks in the data area into the index table. Create a file foot information (Step S260) to mark a file length of the image file, so that other computer devices may confirm the practical data length of the image file after receiving the image file.

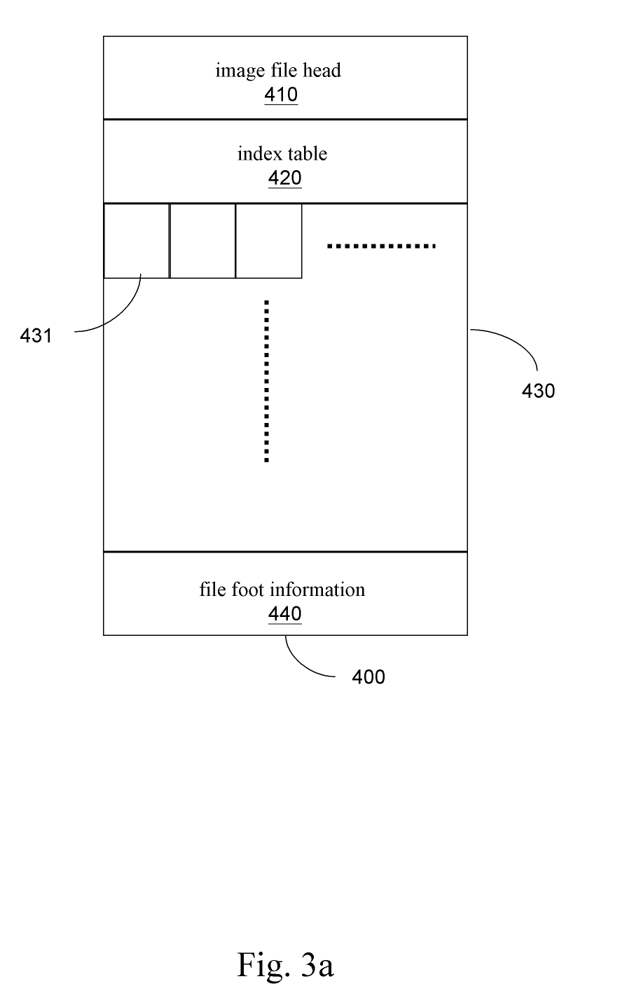

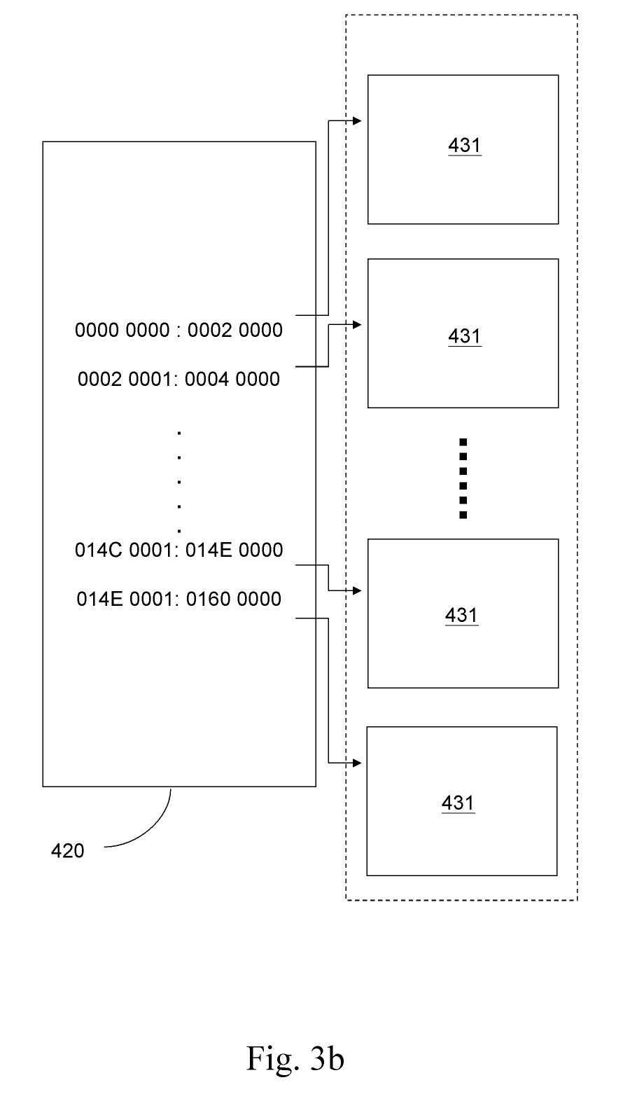

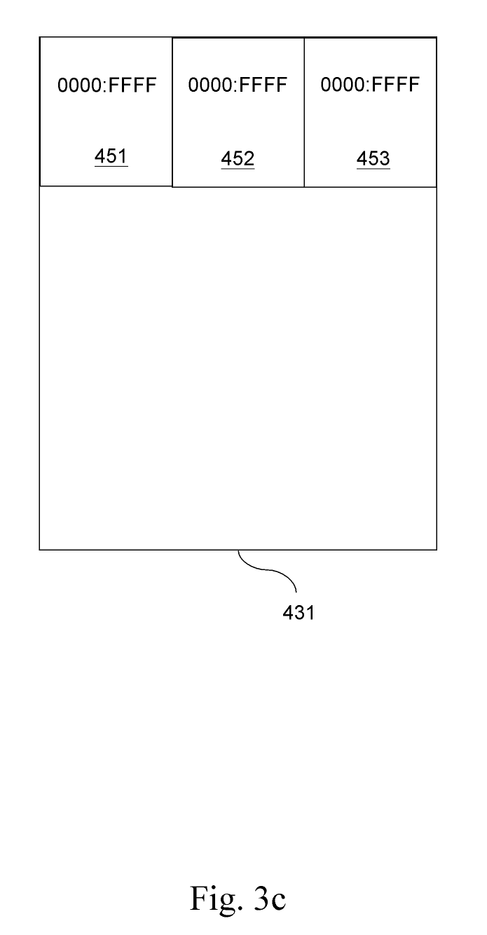

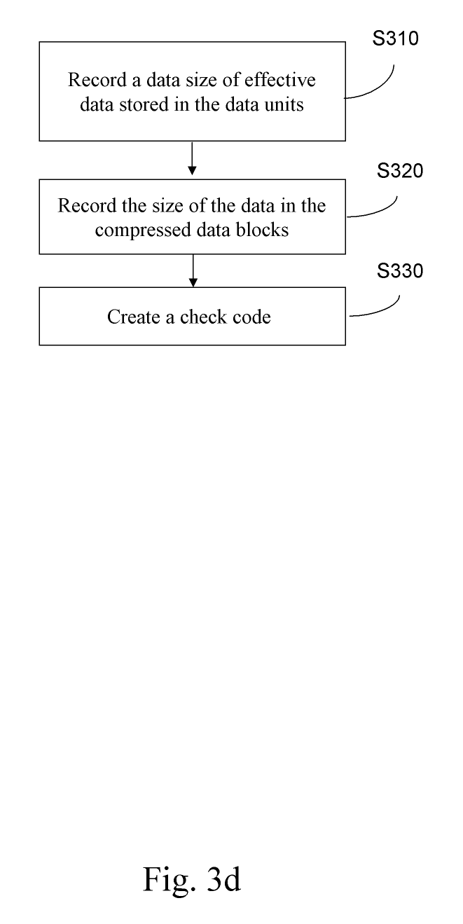

Referring to FIGS. 3a and 3b, a schematic view of a data structure for an image file according to the present invention and a schematic view of an index table according to the present invention are shown respectively. In a preferred embodiment of the present invention, data units are partitioned in the first storage device by a unit of 2 MB. Therefore, a storage device of 20 GB may have 10240 data units, so 10240 compressed data blocks 431 will be generated after the compression step. In an index table 420, an index value is used to record the positions of the compressed data blocks in the first storage device into the index table 420.

The process of recording the file information of the compressed data blocks 431 further includes the following steps. Referring to FIGS. 3c and 3d, a schematic view of the data structure of the compressed data blocks and a flow chart of generating the compressed data blocks are shown respectively.

Record a data size of effective data stored in the data units (Step S310). Please refer to the bit map information in the file systems such as NTFS or Linux EXT for the so-called effective data. In other words, provide an original data length field 451 and the size of the record data field depends on the size of the data units. For example, in the preferred embodiment of the present invention, each of the data units may store 2 MB of data under an ideal situation. However, regarding a practical file storage mechanism, the file data is not always stored in successive blocks, with a result that not all data units store 2 MB of data. If the size of the data stored in each data unit is 2 MB, a record data field may record in a length of 4 bytes.

Therefore, the compressed data blocks 431 record the size of the data actually stored in the data units after being compressed, thereby checking whether the size of the data in the compressed data blocks 431 is consistent with the size of the data before compression when the data is restored.

Record the size of the data in the compressed data blocks (Step S320), and in other words, record the size of the data actually stored in the data units after being compressed. Create a check code (Step S330) to identify and check the compressed data blocks 431. The corresponding check code may be generated by using a cyclic redundancy check, an MD5, or a low-density parity-check (LDPC), so that the data integrity of the compressed data blocks 431 is verified according to the check code after the image file 400 is restored. The lengths of a compressed data block length field 452 and a check code field 453 are also determined according to the size of the data units, and in this embodiment, the length for recording the fields is 4 bytes.

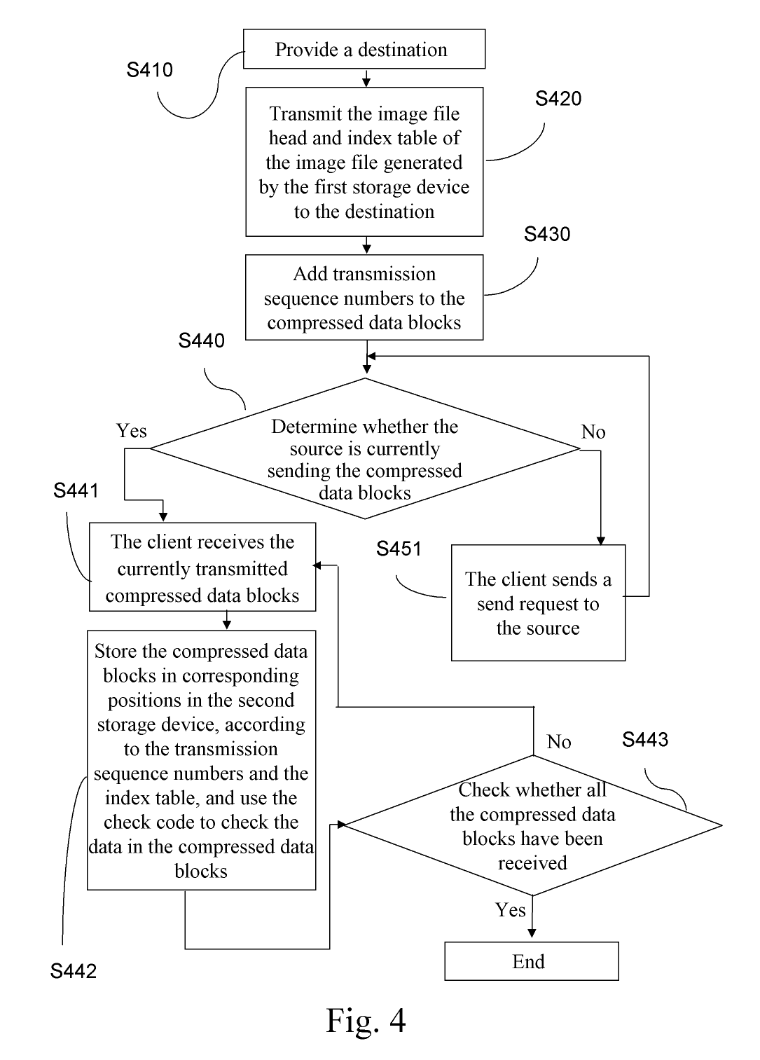

The image file generated in the source not only may enable the source to restore the data in a computer system, but also enable different destinations to restore a computer system. For example, computer manufacturers may perform pre-installation on PCs or notebooks at more than one destination by using an image file stored in the source through a client-server architecture. Referring to FIG. 4, a schematic view of the process of restoring a destination through network according to the present invention is shown. The network transmission includes the following steps.

Provide a destination having a second storage device (Step S410). Transmit the image file head and index table of the image file generated by the first storage device to the destination (Step S420). Add transmission sequence numbers to the compressed data blocks (Step S430). Determine whether the source is currently sending the compressed data blocks (Step S440). If the source is currently sending the compressed data blocks, the destination receives the currently transmitted compressed data blocks (Step S441).

According to the transmission sequence numbers and the index table, store the compressed data blocks in corresponding positions in the second storage device, and use the check code to check the data in the compressed data blocks (Step S442). It should be noted that, the aforementioned index value records the original start positions of the compressed data blocks 431 Tin the first storage device. Therefore, after receiving the index table 420, the destination may restore the data in the second storage device according to the index table 420. At this point, the destination may know the storage positions of the compressed data blocks 431 Tin the first storage device after comparing the received compressed data blocks 431 with the index table 420 in aspect of the storage positions. Thereafter, the destination decompresses the compressed data blocks 431 and writes them into the corresponding positions in the second storage device.

Determine whether all compressed data blocks have been received (Step S443). If the source does not send the compressed data blocks currently, the destination sends a send request to the source (Step S451) to enable the source begin to send the compressed data blocks. Finally, the destination checks whether all the compressed data blocks 431 have been totally received through the index table 420 and file foot information 440.

The image file 400 generated in the present invention not only may restore data for other storage devices through duplication, but also perform data restoration or pre-installation on other storage devices through network transmission. A preferred embodiment is to transmit data to different destinations by using a multicasting transmission technology. The so-called “multicasting” refers to that one host computer may transmit the same data to multiple hosts through a multicasting router at the same time.

The multicasting transmission is characterized in that the source in the network may send the same data to every destination at a time, so as to reduce the transmission amount in the network. If the destination misses one data unit when the image file 400 is transmitted, the destination has to receive the image file 400 again. In order to overcome the defect of missing data units in network transmission, in the present invention, the first storage device is partitioned into multiple data units, and then the data units are compressed. The destination may confirm the storage positions of the compressed data blocks 431 by referring to the image file head 410 and the index table 420. In this manner, the destination may restore the data and store it in the correct positions without sequentially receiving the compressed data blocks 431.

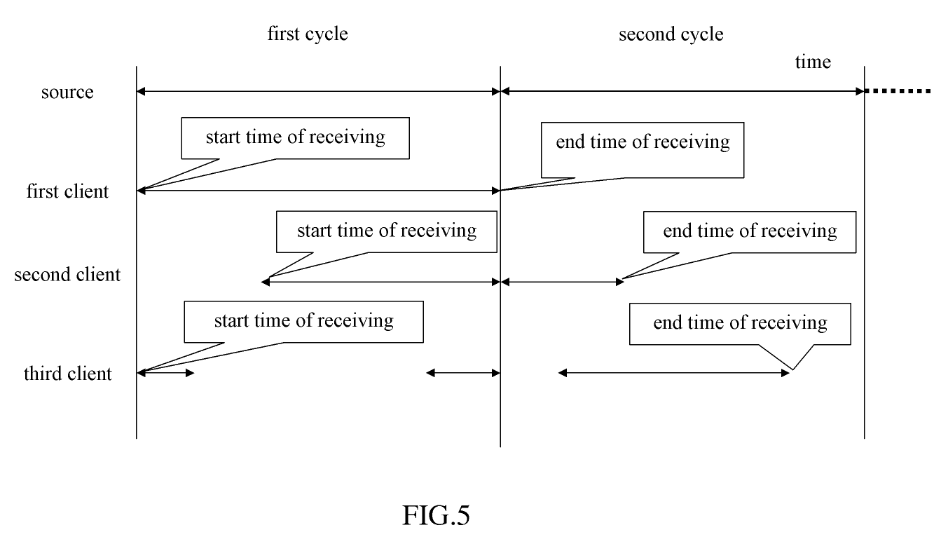

Referring to FIG. 5, a timing graph of the transmission by using the multicasting transmission technology according to the present invention is shown. As shown in an upper portion of FIG. 5, the source transmits the time length of each cycle of the image file 400 by using the multicasting transmission technology. Herein, it is assumed that one cycle of transmission may be performed after each time of transmission, till the source stops transmitting the image file 400. Each of the destinations in FIG. 5 may receive the image file 400 transmitted by the source at different time points. For example, the first destination receives the image file 400 transmitted by the source at the very beginning, and meets no interruption during the transmission. Therefore, after the first cycle, the first destination also has received the image file 400.

A second destination begins to receive the image file 400 in the first cycle. At this time, a second client may store the currently received data units in the corresponding positions of the second storage device according to the index table 420 of the image file 400. Therefore, the second destination may receive the image file 400 as long as it has received the unreceived data units in the second cycle. A third destination does not receive a portion of the image file 400 beginning and ending at the first cycle in the transmission of the first cycle, but it may firstly arrange the data units that have been received according to the image file head 410 and then receive the missed portion of the image file 400 when transmitting the image file 400 in the second cycle.

The present invention provides a method of generating an image file, and the method is used to generate the corresponding image file 400 for a storage device of a source. Generate an image file head 410 according to the hardware parameter information of the storage device; partition the storage device into a plurality of data units, and record the start positions of the data units in an index file; perform a compression process on the data units; and finally, create a file foot information of the image file to mark a file length of the image file.

In the present invention, the image file may be restored in transmission without considering the receiving sequence. During a network transmission period, if the destination has a missed compressed data block, it may firstly restore the data in the compressed data blocks which have been received. Furthermore, in the present invention, the sizes of the data units may be adjusted according to different file storage mechanisms, so that the size of the image file of the present invention may not be limited by a single file capacity of file systems such as EXT, NTFS, FAT16, or FAT32.

What is claimed is:

1. A method of generating an image file, wherein the image file in a first storage device of a source is generated by using a computer to perform following steps, the method comprising:
generating an image file head according to hardware parameter information of the first storage device;
partitioning the first storage device into a plurality of data units with the same size;
performing a compression process to compress data in the data units, respectively, thereby generating corresponding compressed data blocks;
sequentially storing the compressed data blocks in a data area of the image file;
creating an index table to use an index value to record start positions of the data units in the first storage device and positions of the compressed data blocks in the data area into the index table; and
creating a file foot information to mark a file length of the image file.

2. The method of generating an image file as claimed in claim 1, wherein the size of each of the data units is 2 MB.

3. The method of generating an image file as claimed in claim 1, wherein the step of recording file information of the compressed data block further comprises:
recording a data size of effective data stored in the data units;
recording a data size of the compressed data block; and
creating a check code, so as to identify and check the compressed data block.

4. The method of generating an image file as claimed in claim 3, wherein the check code is generated by using a cyclic redundancy check (CRC).

5. The method of generating an image file as claimed in claim 3, wherein the check code is generated by using an MD5.

6. The method of generating an image file as claimed in claim 3, wherein the check code is generated by using a low-density parity-check code (LDPC).
